(19) United States
(12) Patent Application Publication
(10) Pub. No.: US 2014/0095354 A1
(43) Pub. Date: Apr. 3, 2014

(54) REMOTE SYSTEM INTERACTION

(71) Applicant: Wonga Technology Limited, Dublin (IE)

(72) Inventors: Daniel Hegarty, London (GB); Michal Meiri, London (GB); Panni Morshedi, London (GB)

(21) Appl. No.: 13/841,404

(22) Filed: Mar. 15, 2013

(30) Foreign Application Priority Data
Oct. 1, 2012 (GB) 1217563.4

(51) Int. Cl. G06Q 30/06

(52) U.S. Cl. CPC G06Q 30/0613
USPC 705/26.41

(57) ABSTRACT

A computer system includes a processor, a display, one or more input devices allowing a user to input commands into the computer system and a browser which allows the user of the system to browse remote web pages. The computer system is programmed to use the browser to visit a website in response to one or more user commands entered into at least one of the user input devices. Multiple strings are extracted from the visited web page. The probability that the visited web page is one of a predetermined set of types of web pages is determined as a function of whether the strings correspond to a stored list of strings. If the probability is greater than a threshold, an indication is provided on the display that an online loan may be available to the user of the computer system.

### BACKGROUND OF THE INVENTION

This invention relates to methods and systems for improving interactions between client devices, website servers and third party provider systems.

Website providers provide website pages from website servers that users may browse from a client device such as a personal computer, a mobile telephone, tablet device, web TV or any other device operating a browser interface. It is well known that websites may provide user services such as online booking systems, online purchasing systems and other such systems in which the user interacts with the website to provide user data and to execute instructions, such as making bookings, making purchases and so on.

Various approaches are known for enhancing such arrangements to pre-populate information into forms on web pages using cookies stored within a client device. Such approaches typically involve the website provider storing information that may be automatically retrieved after detecting the identity of the user by a standard log in procedure or by detecting a cookie stored at the client device.

Remote third party systems are not typically involved in data transactions between a client device and a website server. Part of the reasoning for this relates to security implications. Web browser software and firewall software typically blocks attempts by third party remote systems to interact with the client device. Often, the only way for a third party to be safely involved in the data flow is for the website server to issue a redirect request which the user device can accept depending upon the security settings of the device software. Such a redirect request directs the entire browser interface to the third party site. However, this approach typically requires an input by a user to cause the redirect and also does not allow the remote service to integrate seamlessly with the web page being viewed.

### SUMMARY OF THE INVENTION

We have appreciated the need to improve the way in which a client device may interact with a remote third party system while receiving and presenting data from a website server. In particular, we have appreciated the need to improve communication between such a remote system and a client device so as to deliver data from the remote system in addition to the data from the website server to the client device. We have particularly appreciated the need for an improvement to the extraction and delivery of data from a browser to a remote third party system to enable interaction with the third party system at appropriate times without interrupting the normal use of a web browser.

The invention is defined in the claims to which reference is now directed.

In broad terms, an embodiment of the invention provides a client device having a module operable to receive one or more web pages from a website server, extract strings from within the web page, send strings to a third party that is remote from the web server remote system, and receive returned data from the third party remote system and use the returned data within the client device. The strings are analysed within the client device to produce vectors describing the categories of strings found within a page. The vectors are analysed to produce a probability that the web page matches one or more criteria to determine whether data should be exchanged with the third party remote system.

The strings are preferably key words within the web page(s) that may be used as a trigger for determining whether to exchange information. The strings may also include the URL of the web page visited.

Preferred features of the invention relate to specific ways of determining features of a website page from which strings should be extracted, in particular to enable any third party system to provide additional data to the client device. In addition, embodiments of the invention allow the remote third party system to supply data to the client device which can then populate the data into website forms for transmission to the website server.

The invention may be embodied in a variety of different systems. Common to such systems is the need to improve the reliability of determining the type of web page, whether it is appropriate to communicate with a third party system, and whether it is appropriate to display additional information in some form of pop-up as a result. Embodiments include security type systems in which it is appropriate only to request security input from a user in response to detection of appropriate types of web pages, authentication systems in which a user wishes to supply information in response to web page type and data provision systems in which a user has selected that they wish to receive additional information from third party providers if certain types of web pages are presented.

The invention may be embodied in methods, client devices, systems, modules within client devices and computer executable code for operating methods embodying the invention.

### BRIEF DESCRIPTION OF THE DRAWINGS

The invention will now be described in more detail by way of example with reference to the drawings, in which:

FIG. 1: is a schematic diagram of a system embodying the invention;

FIG. 2: shows the main functionary units of a client device embodying the invention;

FIG. 3: shows the main process steps undertaken at a client device embodying the invention;

FIG. 4: shows detail of a process for extracting and using data according to the invention;

FIG. 5: is a diagram showing the broad message flows in a system embodying the invention; and

FIG. 6: is a sample browser with the extension/plugin activated.

### DETAILED DESCRIPTION OF THE PREFERRED EMBODIMENTS

The invention may be embodied in methods of operating client devices, methods of using a system involving a client device, client devices, modules within client devices and computer instructions for controlling operation of client devices. The invention may be embodied, for example, in (i) a web toolbar for E-commerce websites within an iFrame or toolbar that pops up on ecommerce websites; (ii) mobile app; or (iii) tablet app. Client devices include personal computers, smart phones, tablet devices and other devices useable to access remote services.

For ease of understanding, a system embodying the invention will be described first, followed by details of client devices and methods and message flows. The embodiment described is a system that determines that a product page or checkout page on a website is being viewed by a user and indicates the availability of an online credit arrangement for payment of goods.

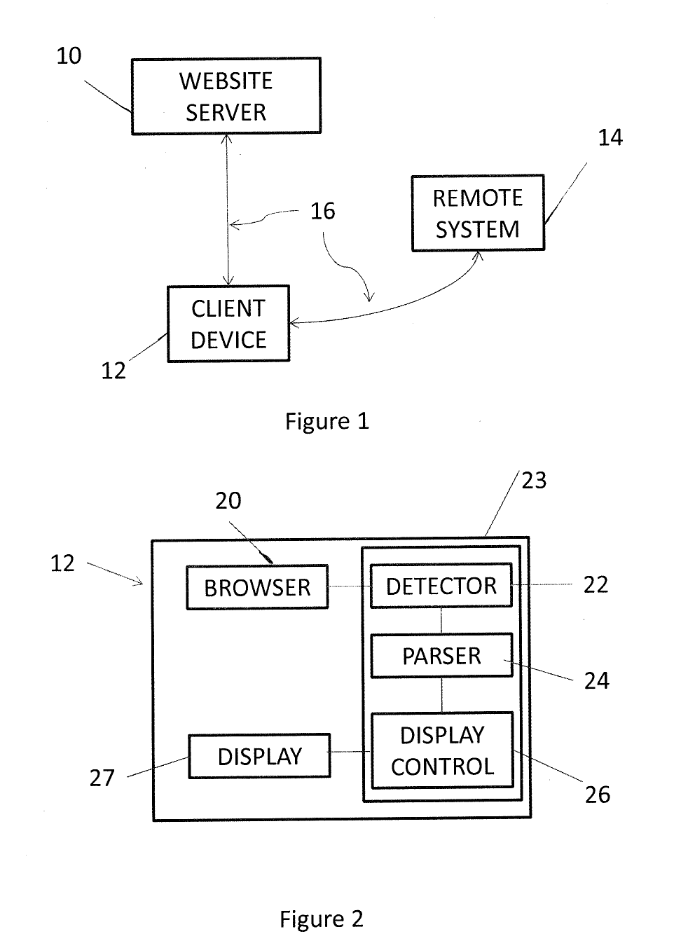

A system embodying the invention is shown in FIG. 1 and comprises a website server 10 for providing web pages, one or more client devices 12 for receiving, presenting and interacting with the web pages and a remote system 14 separate from both the website server and client devices for providing additional interaction with the client device. The client device connects with the website server 10 and remote system 14 over a network 16, preferably the internet, but other technologies, whether wired or wireless, may be used in the communication path.

Remote system 14 may be a self-contained system holding data available to client devices, but can also be a system that provides connectivity to other sources of data and functionality. The remote system 14 may thereby both retrieve data from other systems for provision to the client device, but may also provide instructions to other systems as a consequence of interaction with the client device.

The main functional components of a client device in accordance with one embodiment of the invention are shown in FIG. 2. The client device 12 includes a browser 20 by which web pages may be navigated and displayed on a display 27, and through which the user may control access to one or more websites. As already noted, the client device may be a personal computer, tablet, smart phone, web TV or other such device and includes a processor 23 that implements a plug-in and display 27. The device includes the following additional functional components operable on the device including a detector 22, parser 24 and a display control 26, which may collectively be provided by a plug-in, extension or additional functionality to a standard web browser. The plug-in or extension functionality may be considered a module in the sense that it is a separate functional component operable in conjunction with a web browser of the client device. This may be provided by executable code, separate hardware, but is preferably a web browser plug-in. The plug-in, extension or the like is shown as module 23 in FIG. 2. The plug-in may be downloaded to the client device from the remote system 14 prior to use, or may be downloaded just prior to use in response to user request.

The detector 22 executes processes which monitor the web pages navigated by the browser 20. The detector identifies components of the web pages using strings including the URL, text used, font sizes and colours. The detector provides this information to the parser 24 which analyses the data in various ways as will be described later. The purpose of the parser 24 is to analyse data relating to the web pages and to indicate if specific data items or components are present such that data should be exchanged with the remote third party system and, ultimately, the display controlled so as to indicate to the user, the availability of additional information or services from the third party system. The parser 24 provides the results of the analysis process to a display control 26 which then provides the appropriate indication to the user by way of pop-up graphic, additional text, status bar or other such visual indication.

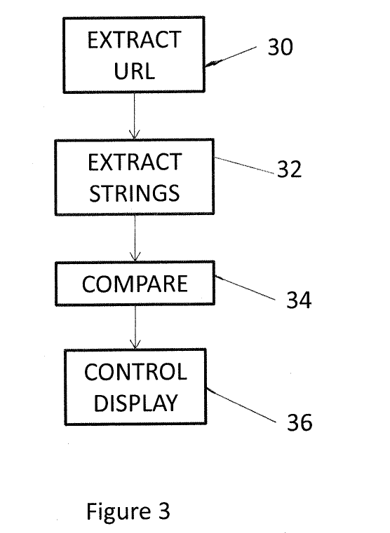

In the preferred embodiment, the broad steps involved in the process of operating the device are summarised in FIG. 3 and comprise extracting components such as the URL at step 30, extracting certain string components from web pages 32, comparing the extracted strings or text and other components at step 34 and determining whether to exchange data with a remote third party system and controlling a display 36 as a result of the comparison.

The processes of this disclosure may be used in a variety of arrangements. The common theme is the process operated at a plug-in module of the client device to identify a web page presented from a web server for which communication should be initiated with a third party system so as to exchange data with that remote third party system. Such third party data exchange may be, for example, for authentication purposes so as to provide some independent third party validation of a user. Alternatively, the purpose may be for provision of additional data to a user related to a web page being visited. A particular example relates to the need to identify that a browser is visiting a web page from which items may be purchased and to communicate information relating to such potential purchases to a third party system. The presence of such a “product page” may be identified for security purposes so as to ensure protection of users and to refer to the remote third party system for security clearance. A second possible reason is to allow the remote third party system to interact with the web browser to provide data in relation to a potential purchase. In all of these preferred examples, common to the system is the way in which the nature of the web page is identified as will now be described.

To facilitate understanding, a particular example of using the system in relation to online purchases will be described followed by a more detailed discussion of the processes and message flows. The example relates to online shopping and to the detection of product pages and to the exchange of data with a third party provider with credit to allow a user to complete a purchase using credit provided by or facilitated by the third party.

A user navigates to a page that shows a product. The detector within the plugin of the client device extracts key information from the page to determine if the page is a product page, checkout page or the like. The first data extracted is the URL of the page. An example set of expressions extracted and used for this prediction is shown in Appendix 1. If the URL matches one of these pre-stored expressions, then the page might be a product page. The parser 24 receives the URL and compares to the list of regular expressions as a first step in determining if the page is in fact displaying a product for sale. In this way, the client device and in particular the plug-in by which the detector, parser and display control are preferably implemented, may determine if there is potentially a product page being displayed from any website.

The next step in detection of appropriate web pages, such as product pages and checkout pages, involves using a combination of strings, in particular keywords. A set example of keywords is shown in Appendix 2. As before, the detector extracts words from the markup language of the web page and, using the parser, a search is conducted for certain key words based on the 17 separate categories shown in Appendix 2. Using training web pages, the keywords in the 17 categories are analysed using regression analysis to produce a model that implements detection for future web pages. The parser loads the entire web page and checks the whole page text for the appearance of the words in the 17 categories. If any word within a given category is present, then the word groups in which that word may be found are deemed to be present and data vector built to describe the page. For example, if the words “in stock”, “add to basket” and “quantity” are present then word groups 0, 6 and 8 are deemed to be present and data vector can be constructed to describe this in the form (1,0,0,0,0,0, 1,0,1,0,0,0,0,0,0,0,0).

The detector 22 and browser 24 may operate on a single web page that is being viewed at the present time. In addition, the detection and parsing of strings may be from multiple web pages viewed over a sequence of browsing events leading up to the web page currently being viewed. In a sense, the web pages forming part of the navigational journey of the user may be analysed by the detector and parser to be used as part of the assessment as to whether the web page currently being viewed should pause some further action such as display of the pop-up or communication with the remote system.

The data vector shown has 17 elements because there are 17 different categories in this embodiment. Other numbers of categories may be used. If at least one keyword from the category with index ‘i’ is found then element V[i] equals 1, or 0 otherwise. Hereafter we will call these binary vectors “category vectors”. It would be possible to use real vectors representing confidence/probability in the occurrence of the feature, but binary vectors are used in this embodiment.

In this embodiment, a database of 513 web pages is used. For each of these pages we defined the page type to be one of following:

“Product page”,

“Catalog page”,

“Checkout page”

“Normal page” (neither product, catalog or checkout page).

The database was analysed and models created using binary logistic regression to create models that predict for a given page probabilities of being a product page, a catalog page and a checkout page. They work as follows: assume we have a category vector V for a page whose page type we want to predict.

The probability of a page being a product page may then be calculated using equations of the form:

Zpr=Cpr+C₀*V₀*+ . . . +CₙVₙ

Where Cpr is a constant for the system and Cₙ is a constant applicable to vector N. Similar calculations are performed for each of the other types of pages to be determined, for example Catalog pages and Payment pages.

Zct=Cpr+C₀*V₀C₁*V₁+ . . . +CₙVₙ

Zpm=Cpr+C₀*V₀+C₁*V₁+ . . . +CₙVₙ

The probabilities are then given by:

$${P}_{product page} = \frac{1}{1 + {e}^{- Zpr}} \\ {P}_{catalog page} = \frac{1}{1 + {e}^{- Zct}} \\ {P}_{payment page} = \frac{1}{1 + {e}^{- Zpm}} \qquad Equations 1$$

All coefficients in these models have been calculated using statistical analysis software tools, in order to estimate the probabilities that a given page is a page of one of the desired page types. The above analysis gives four possible outcomes namely that the page is a product page, a catalog page, a payments page or some other type of page. If more than one probability is greater than a threshold then the page is determined to be the page type that has the maximum probability.

The vectors for 17 word groups discussed above may be plotted on a vertical and horizontal axis showing for each square within a 17 by 17 matrix example where more than group of words is present.

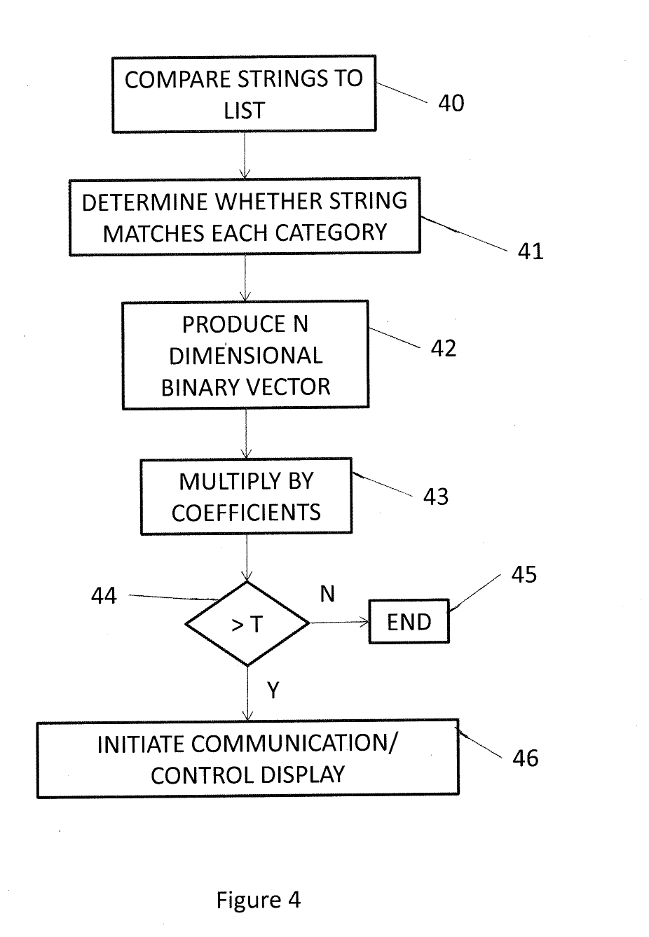

The process described above relating to the comparison block 34 is summarised in FIG. 4. As shown, the initial step is to compare strings from a web page to a defined list at step 40 and to determine whether any string within the web page matches one or more categories as defined by the list at step 41. The existence of a string in a given category is denoted by a one and the absence by a zero so as to form an N dimensional binary vector at step 42. The vector is multiplied by chosen coefficients at step 43 to produce a summed value. A probability is calculated from this multiplication as a function of this summed value and the probability compared to a threshold at decision step 44. If the probability is not above a threshold then the process ends at step 45. If the probability for a given type of page is above a threshold then communication with the third party remote server may be initiated and additional steps taken to control the display of the web page at step 46.

The detector and parser also determine which fields on a page may allow input of data, for example, using hypertext markup language elements on a page and selecting all “input” and “select” elements. In addition, various tags such as “name”, “class” and “ID” values are analysed or predefined key words such as “name” “address” and so on.

Using the techniques described above, the detector, parser and display control which together may be implemented by a browser plug-in, determine the type of page the user is viewing. Depending upon the results, the display is controlled to indicate to the user the availability of data or services from a third party website, in particular the ability to select to purchase the item using credit from a third party provider.

At this stage, the client device uses a plug-in to communicate with the remote third party system and transmits the price of an item displayed on the web page. In addition, any other available data might be transmitted including an identifier for the user using the client device, the nature of the product or key words describing the product being displayed and any other data relevant to the third party provider of credit. The client device receives financial information from the remote third party system, in particular an initial amount to be paid, any subsequent instalments to be paid for a loan and the total price for the loan. This information may be displayed by the display control 24 in a pop up or on a status bar or potentially even within the web page itself adjacent to the product for which the price is being displayed.

The identification of some strings such as a price within a web page is not a trivial task and the following description sets out how, in the preferred embodiment, the detector and parser are able to detect this information from within a web page.

The following approach is taken to determine the price:

1. Snippets (microformat data)

Sometimes page metadata contains the product price information. In that case the empirical algorithm is not used, and it is assumed that the price in the metadata is correct.

2. Otherwise, the algorithm described below is applied:

Step 1: The system loops through the page Document Object Model elements finding their inner text in lower case without quotes and whitespaces (hereafter just “text”). All elements that meet the following requirements are stored:
Element's text matches one of the regular expressions listed below.
Price value regular expressions:
   ̂((only|now|price|from|sale)(:)?)?(\u00a3|gbp)(\d+([\.,]\d+)*)$
   ̂((only|now|price|from|sale)(:)?)?(\u00a3|gbp)(\d+(?:[\.,]\d+)*)(−|to)(\u00a3|gbP)?
   (\d÷([\.,]\d+)*)$
Element is visible.
Element has no child elements whose text matches the same regular expression.
Element's text is not lined through.
If element's text matches the first regular expression it should not have a parent element whose text matches the second one.

Step 2: The biggest image on the page (the one most likely to be the product photo) is sought. All invisible images and images with a large top offset (greater than 900px) are ignored.

Step 3: The stored elements array from Step 1 is filtered, leaving only elements that have maximum screen height.

Step 4: Distances from the centre of every element in the array from Step 3 to the centre of the image from Step 2 are measured, using Euclidean distance square and screen coordinates in pixels.

Step 5: It is assumed that the product price is located in the element closest to the biggest image found at Step 2, so the minimum distance value is searched for.

The web browser plug-in of the client device can also pre-populate data in response to granting it credit. The same keywords-based approach as for page type detection is used.

A sample database was created containing 184 items with information about input fields on supported websites. Using a statistical software analysis tool a number of binary regression models were created to estimate for a given input field the probabilities of being one of the supported types.

The following approach was applied to determine form fields:
All “input” and “select” elements of the page are obtained.
The “name”, “class” and “id” attribute values are detected and compared with predefined keywords (“name”, “address” and other).
The supported fields are populated (table below)

If the user selects to use credit from the third party provider, the remote system supplies payment information which is used by the plug-in to populate direct into the website.

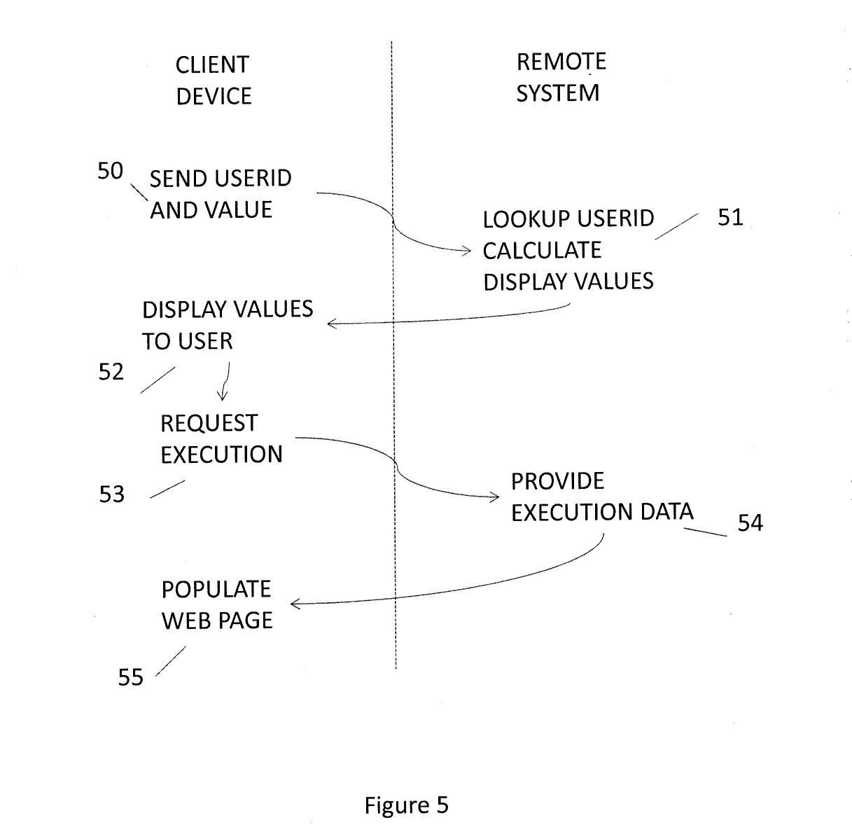

The message flows within the systems may be summarised as shown in FIG. 5. If it is determined that a particular type of page is being viewed by the web browser using the techniques described above, then any relevant information such as a price value is extracted from the web page as described above, and a user ID of the user of the device is extracted and sent to the remote third party system at step 50. The remote third party system then looks up the user ID and performs any additional security checks required and then calculates an appropriate price value for display to the user showing the amount payable if a loan is taken using the provider of the third party system. This information is transmitted to the client device and displayed to the user at step 52. If the user requests execution of a loan and payment into the web page being viewed at step 53, this request is transmitted to the remote system and appropriate execution data provided at step 54 which is populated by the client device into the web page at step 55 so as to allow completion of the purchase. The message flow shown in FIG. 5 is just one example relating to an online purchasing system, and similar message flows would apply to other uses of the systems and processes of the invention.

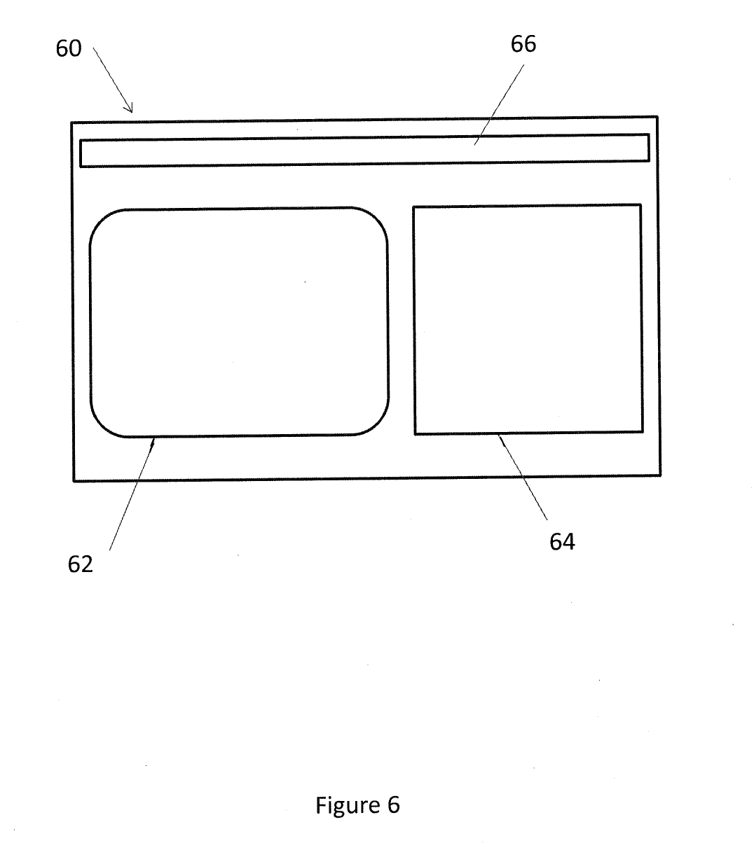

For completeness, a schematic diagram of the appearance of the web browser using a pop-up status bar implemented by the plug-in is shown in FIG. 6. The browser display 60 may comprise one or more images 62 and other objects such as text portions 64. In addition, the plug-in or extension to the web browser may initiate a pop-up status bar 66 in the manner described herein.

APPENDIX 1
Sample regular expression used for Product Pages:
\hat{ }(http|https)://www\.amazon\.co\.uk/(gp/product|[A-Za-z0-9_-]*/dp|dp)/[A-Z0-9]{3,10}
Sample regular expression used for Payment Pages:
https://secure.tesco.com/direct/my/checkout-payment.page

APPENDIX 2
Sample Keyword categories

| Name | Keywords | Index | Description |
|---|---|---|---|
| Status | in stock | 0 | Matches current |
| | in store | | product state. |
| Reviews | read all reviews | 1 | Matches user |
| | add/write/create a review | | reviews. |
| Information | product/item description | 2 | Matches product |
| | product/item details | | information. |
| Delivery | delivery | 3 | Matches “delivery” |
| | | | word. |
| Buy | buy | 4 | Matches “buy” word. |
| Code | product/item code | 5 | Matches product |
| | catalog number | | code. |
| Add | add to | 6 | Matches add button. |
| | basket/cart/bag/card/ | | |
| | compare | | |
| Price | price | 7 | Matches prices. |
| | cost | | |
| Count | quantity | 8 | Matches product |
| | qty | | count. |
| Sort | sort by | 9 | Matches item lists. |
| Card no | card number/no | 10 | Matches card |
| | | | number. |
| Name on card | cardholder name | 11 | Matches cardholder |
| | cardholder's name | | name. |
| Expiration date | expiration/expiry/end/ | 12 | Matches card start or |
| | start date | | end date. |
| Card cv2 | security code/number | 13 | Matches card security |
| | card verification code | | code. |
| Card type | card type | 14 | Matches card type. |
| | debit or credit | | |
| | credit or debit | | |
| Payments title | payment [card] options/ | 15 | Matches payment |
| | details card details/method | | details label. |
| Additional | issue number | 16 | Matches commonly |
| checkout | visa | | used words on |
| keywords | | | checkout pages. |

1. A computer system comprising a processor, a display, one or more user input devices allowing a user to input commands into the computer system and a browser which allows the user of the system to browse remote web pages, the computer system being programmed to carry out the following process:
using the browser to visit a web page in response to one or more user commands entered into at least one of the user input devices;
extracting multiple strings from the visited web page;
calculating the probability that the visited web page is one of a predetermined set of types of web pages as a function of whether the strings correspond to a stored list of strings; and
if the probability is greater than a threshold, providing an indication on the display that an online loan may be available to the user of the computer system.

2. The computer system of claim 1, wherein the probability is calculated as a function of both strings extracted from the visited web page and strings extracted from other web pages of the same web site which had previously been visited by the browser.

3. The computer system of claim 1, wherein the computer system carries out the probability calculation by determining whether each string matches a string on the stored list of strings and for each matching string:
identifying a corresponding category for that string to produce a list of categories for which strings are found; and
calculating the probability that the visited web page is of a particular predetermined type as a function of the number of categories in the list of categories.

4. The computer system of claim 3, wherein the probability is calculated as a weighted function of each identified category, some categories having a higher weight than others.

5. The computer system of claim 3, wherein at least some of the categories in the list of categories have more than one corresponding string.

6. The computer system of claim 4, wherein the weighted function comprises producing an N dimensional vector, each dimension representing one of the categories.

7. The computer system of claim 6, wherein the vector is a binary vector.

8. The computer system of claim 4, wherein the weighted function is as defined in Equations 1 herein.

9. The computer system of claim 1, wherein the strings comprise words displayed on the web page.

10. The computer system of claim 1, wherein the strings include parts of the URL of the web page.

11. The computer system of claim 1, wherein the system being further programmed to control the display of the device to indicate that the web page is a product page and to provide information regarding a potential online loan from an online lender.

12. The computer system of claim 8, wherein the control of the display includes providing a pop-up that includes data retrieved related to a loan in dependence on one or more of the strings.

13. The computer system of claim 8, wherein the control of the display includes indicating one or more of a loan amount, cost of lending, terms of lending or interest rate of an online lender depending upon the results of the comparison.

14. The computer system of claim 8, programmed to retrieve data from the online lender for display depending upon the results of the comparison.

15. The computer system of claim 8, programmed to retrieve data from the third party system based on multiple web pages visited during the web browsing session.

16. The computer system of claim 1, programmed to identify a price within a web page by searching for strings within the page matching one or more expressions and determining their proximity to an image on the web page.

17. The computer system of claim 13, wherein the image on the web page is the one of a plurality of images on the web page selected according to attributes of the image.

18. The computer system of claim 14, wherein the attributes include the relative image size and the image selected is the largest such image.

19. The computer system of claim 13, wherein the feature identified is the element with the closest proximity to the image.

20. The computer system of claim 16, wherein the proximity is the distance from the element to the centre of the image.

21. The computer system of claim 13, wherein the strings matching the one or more expressions are restricted to those having a given size.

22. The computer system of claim 1, wherein the extraction of strings comprises using optical character recognition techniques.

23. A plug-in for a computer system comprising one or more processors, a display, one or more user input devices allowing a user to input commands into the computer system and a browser which allows the user of the system to browse remote web pages, the plug-in comprising a non-transitory computer medium having program instructions stored thereon which, when executed on one or more of the processors casuses the computer system to carry out the following process:
extracting multiple strings from a web page visited by the user of the computer system;
calculating the probability that the visited web page is one of a predetermined set of types of web pages as a function of whether the strings correspond to a stored list of strings; and
if the probability is greater than a threshold, providing an indication on the display that an online loan may be available to the user of the computer system.

24. The plug-in of claim 23, wherein the probability is calculated as a function of both strings extracted from the visited web page and strings extracted from other web pages of the same web site which had previously been visited by the browser.

25. The plug-in of claim 23, wherein the computer system carries out the probability calculation by determining whether each string matches a string on the stored list of strings and for each matching string:
identifying a corresponding category for that string to produce a list of categories for which strings are found; and
calculating the probability that the visited web page is of a particular predetermined type as a function of the number of categories in the list of categories.

26. The plug-in of claim 25, wherein the probability is calculated as a weighted function of each identified category, some categories having a higher weight than others.

27. The plug-in of claim 25, wherein at least some of the categories in the list of categories have more than one corresponding string.

28. The plug-in of claim 26, wherein the weighted function comprises producing an N dimensional vector, each dimension representing one of the categories.

29. The plug-in of claim 28, wherein the vector is a binary vector.

30. The plug-in of claim 28, wherein the weighted function is as defined in Equations 1 herein.

31. The plug-in of claim 23, wherein the strings comprise words displayed on the web page.

32. The plug-in of claim 23, wherein the strings include parts of the URL of the web page.

33. The plug-in of claim 23, wherein the system being further programmed to control the display of the device to indicate that the web page is a product page and to provide information regarding a potential online loan from an online lender.

34. The plug-in of claim 33, wherein the control of the display includes providing a pop-up that includes data retrieved related to a loan in dependence on one or more of the strings.

35. The plug-in of claim 33, wherein the control of the display includes indicating one or more of a loan amount, cost of lending, terms of lending or interest rate of an online lender depending upon the results of the comparison.

36. The plug-in of claim 33, programmed to retrieve data from the online lender for display depending upon the results of the comparison.

37. The plug-in of claim 33, programmed to retrieve data from the third party system based on multiple web pages visited during the web browsing session.

38. The plug-in of claim 23, programmed to identify a price within a web page by searching for strings within the page matching one or more expressions and determining their proximity to an image on the web page.

39. The plug-in of claim 38, wherein the image on the web page is the one of a plurality of images on the web page selected according to attributes of the image.

40. The plug-in of claim 39, wherein the attributes include the relative image size and the image selected is the largest such image.

41. The plug-in of claim 38, wherein the feature identified is the element with the closest proximity to the image.

42. The plug-in of claim 41, wherein the proximity is the distance from the element to the centre of the image.

43. The plug-in of claim 38, wherein the strings matching the one or more expressions are restricted to those having a given size.

44. The plug-in of claim 23, wherein the extraction of strings comprises using optical character recognition techniques.

45. A method operable on computer system comprising a processor, a display, one or more user input devices allowing a user to input commands into the computer system and a browser which allows the user of the system to browse remote web pages, method comprising the following process:
using the browser to visit a web page in response to one or more user commands entered into at least one of the user input devices;
extracting multiple strings from the visited web page;
calculating the probability that the visited web page is one of a predetermined set of types of web pages as a function of whether the strings correspond to a stored list of strings; and
if the probability is greater than a threshold, providing an indication on the display that an online loan may be available to the user of the computer system.

46. The method of claim 45, wherein the probability is calculated as a function of both strings extracted from the visited web page and strings extracted from other web pages of the same web site which had previously been visited by the browser.

47. The method of claim 45, wherein the computer system carries out the probability calculation by determining whether each string matches a string on the stored list of strings and for each matching string:
identifying a corresponding category for that string to produce a list of categories for which strings are found; and
calculating the probability that the visited web page is of a particular predetermined type as a function of the number of categories in the list of categories.

48. The method of claim 47, wherein the probability is calculated as a weighted function of each identified category, some categories having a higher weight than others.

49. The method of claim 47, wherein at least some of the categories in the list of categories have more than one corresponding string.

50. The method of claim 48, wherein the weighted function comprises producing an N dimensional vector, each dimension representing one of the categories.

51. The method of claim 50, wherein the vector is a binary vector.

52. The method of claim 48, wherein the weighted function is as defined in Equations 1 herein.

53. The method of claim 45, wherein the strings comprise words displayed on the web page.

54. The method of claim 45, wherein the strings include parts of the URL of the web page.

55. The method of claim 45, wherein the system being further programmed to control the display of the device to indicate that the web page is a product page and to provide information regarding a potential online loan from an online lender.

56. The method of claim 55, wherein the control of the display includes providing a pop-up that includes data retrieved related to a loan in dependence on one or more of the strings.

57. The method of claim 55, wherein the control of the display includes indicating one or more of a loan amount, cost of lending, terms of lending or interest rate of an online lender depending upon the results of the comparison.

58. The method of claim 55, programmed to retrieve data from the online lender for display depending upon the results of the comparison.

59. The method of claim 55, programmed to retrieve data from the third party system based on multiple web pages visited during the web browsing session.

60. The method of claim 45, programmed to identify a price within a web page by searching for strings within the page matching one or more expressions and determining their proximity to an image on the web page.

61. The method of claim 60, wherein the image on the web page is the one of a plurality of images on the web page selected according to attributes of the image.

62. The method of claim 61, wherein the attributes include the relative image size and the image selected is the largest such image.

63. The method of claim 60, wherein the feature identified is the element with the closest proximity to the image.

64. The method of claim 63, wherein the proximity is the distance from the element to the centre of the image.

65. The method of claim 60, wherein the strings matching the one or more expressions are restricted to those having a given size.

66. The method of claim 45, wherein the extraction of strings comprises using optical character recognition techniques.
